(19) United States
(12) Patent Application Publication
(10) Pub. No.: US 2013/0025708 A1
(43) Pub. Date: Jan. 31, 2013

(54) DRAIN COMPONENT

(71) Applicant: Johannes Dallmer, Arnsberg (DE)

(72) Inventor: Johannes Dallmer, Arnsberg (DE)

(73) Assignee: DALLMER GMBH & CO. KG, Arnsberg (DE)

(21) Appl. No.: 13/557,680

(22) Filed: Jul. 25, 2012

(30) Foreign Application Priority Data
Jul. 26, 2011 (DE) 10 2011 108 540.1
Nov. 25, 2011 (EP) 11190820.8
Dec. 23, 2011 (EP) 11195624.9

(51) Int. Cl. F16L 5/00

(52) U.S. Cl. 137/362

(57) ABSTRACT

Drain component having a surface which in the installed state of the drain component may at least partially come in contact with one or several layers of a floor structure, wherein connecting means are at least partially arranged on the surface of the drain component for forming a connection to one or several layers of the floor structure. The drain component may include, for example, a tubular section (1) and a flange (2) protruding outwardly from the tubular section (1), wherein connecting elements (7) for the interlocking connection with a screed are arranged, for example, on the bottom side (6) of the flange (2), as viewed in the installed position.

### CROSS-REFERENCE TO RELATED APPLICATIONS

The present patent application claims the right of priority under 35 U.S.C. §119 (a)-(d) of German Patent Application No. DE 10 2011 108 540.1, filed Jul. 26, 2011; European Patent Application No. EP 11190820.8, filed Nov. 25, 2011; and European Patent Application No. EP 11195624.9, filed Dec. 23, 2011.

### BACKGROUND OF THE INVENTION

1) Field of the Invention

The present invention relates to a drain component having a surface which, in the installed state of the drain component, comes at least partially into contact with one or several layers of a floor structure.

(2) Description of Related Art

A drain component of this type may be formed, for example, as a drain bowl or an extension part for a discharge device and may at least be partially made of plastic. The drain component may include a flange that rests on a layer of the floor structure, for example on a screed, and serves as a substrate for a composite waterproof seal and tiles disposed thereon. With prior art drain components there is a risk that the flange which rests loosely on the layer of the floor structure deforms under load. This can lead to cracks in the adhesive and the composite waterproof seal, causing leaks.

The underlying object of the present invention is to provide a drain component of the aforementioned type, which resists deformation in the installed state and/or has better adhesion to one or several layers of the floor structure.

### BRIEF SUMMARY OF THE INVENTION

This objective is attained according to the invention with a drain component of the aforementioned type having connecting means for connecting to one or several layers of the floor structure which are disposed at least partially on the surface of the drain component.

The dependent claims recite preferred embodiments of the invention.

According to the claimed invention, the connecting means for connecting to one or several layers of the floor structure are arranged at least partially on the surface of the drain component. In this way, the surface of the drain component provided with the corresponding connecting means makes a fixed connection with one or several layers of the floor structure. For example, vibrations can no longer be excited in the flange or are at least less likely to be excited, when the connecting means are arranged on the underside of a flange.

The connecting means may be formed as flocking or may include flocking. The flocking may be arranged over the full surface or a partial surface of the drain member. The flocking may include synthetic fibers, such as polyamide fibers or polyester fibers, or natural fibers, such as for example flax or hemp. Flocking, which form very effective adhesion bridges with the surrounding layers of the floor structure, such as a screed, and/or with a composite waterproof seal and/or with a tile adhesive and/or with a concrete section and/or with a wooden section of the floor structure may be manufactured with these materials.

Alternatively or in addition, the connecting means may be formed as a fleece or may include a fleece. The fleece may be arranged over the full surface or a partial surface of the drain member.

For example, the fleece and/or the fibers or flocks used as flocking may be molded on or injected in the surface of the drain component at least in sections. The fleece or the flocking then adheres very well to the drain component and can thus form a very effective adhesion bridge with the surrounding layers of the floor structure, such as for example a screed, and/or with a composite waterproof seal and/or with a the adhesive and/or with a concrete section and/or with a wooden section of the floor structure.

Alternatively, the fleece and/or the fibers or flocks used as flocking may be glued to the surface of the drain component at least in sections.

The flocking and/or the fleece may be constructed to form a material connection with one or several layers of the floor structure. This creates a solid connection with the corresponding layer(s) of the floor structure.

Alternatively or in addition, the connecting means may include at least one connecting element, which in the installed position points at least in sections or partially away from the surface of the drain component. A gap may be present between a section of the at least one connecting element and the surface of the drain member. In particular, the at least one connecting element may be designed so as to form an interlocking connection with one or several layers of the floor structure. The at least one connecting element may therefore also cause a solid connection between a part of the surface of the drain member and one or several layers of the floor structure.

The connecting element may have a dimension in the direction away from the drain component between 0.1 mm to 150 mm. For example, the dimension may be between 3 mm and 30 mm. The connecting element may be, for example, hook-shaped or mushroom-shaped.

The at least one connecting element may be formed integrally with the drain component or may be connected with the drain component as a separate part, in particular releasably, for example via a screw connection or a clip connection or a catch connection. Both embodiments of the connecting element may also be simultaneously arranged on a drain component. The one-piece design allows a more efficient production, whereas the design as a separate detachable part allows a variable attachment when needed.

The connecting element may in the installed position at least in sections or partially protrude downwardly from the bottom side of a flange. The at least one connecting element may be designed so as to form an interlocking connection with a screed. For example, a gap may be present at least in sections between the at least one connecting element and the side of the flange that forms the bottom side in the installed position. Alternatively, a plurality of connecting elements may be provided.

The drain member may include a tubular or elongated channel-shaped section through which waste water can pass, and a flange extending outwardly from the tubular or elongated channel-shaped section, wherein the connecting means for forming a connection with one or several layers of the floor structure are arranged on the flange. For example, the connecting means may be arranged on the bottom side of the flange, as viewed in the installed position, and/or on the top side of the flange, as viewed in the installed position.

The drain member may be formed as an extension part for drain assembly.

The drain member may also be part of a drain assembly, wherein in particular the tubular or elongated channel-shaped section is part of a drain bowl.

Both the drain component formed as an extension part as well as the drain component formed as a drain bowl may have a cylindrical or a groove-like shape. The drain and/or the inlet opening may thus be constructed point-shaped and/or rotationally symmetric, as well as line-shaped and/or as an elongated channel.

### BRIEF DESCRIPTION OF THE SEVERAL VIEWS OF THE DRAWING(S)

Additional features and advantages of the present invention will become apparent from the following description of preferred exemplary embodiments with reference to the accompanying drawings, which show in

FIG. 1 a view of a first embodiment of a drain component according to the invention from below;

FIG. 2 a section according to the arrows II-II in FIG. 1;

FIG. 3 a detailed view according to arrow III in FIG. 2;

FIG. 4 in a partial section, a perspective view of a second embodiment of a drain component according to the invention;

FIG. 5 a plan view on a third embodiment of a drain component according to the invention;

FIG. 6 a section according to the arrows VI-VI in FIG. 5; and

FIG. 7 a detailed view according to arrow VII in FIG. 6.

### DETAILED DESCRIPTION OF THE INVENTION

Identical or functionally identical parts in the figures are denoted with identical reference numerals.

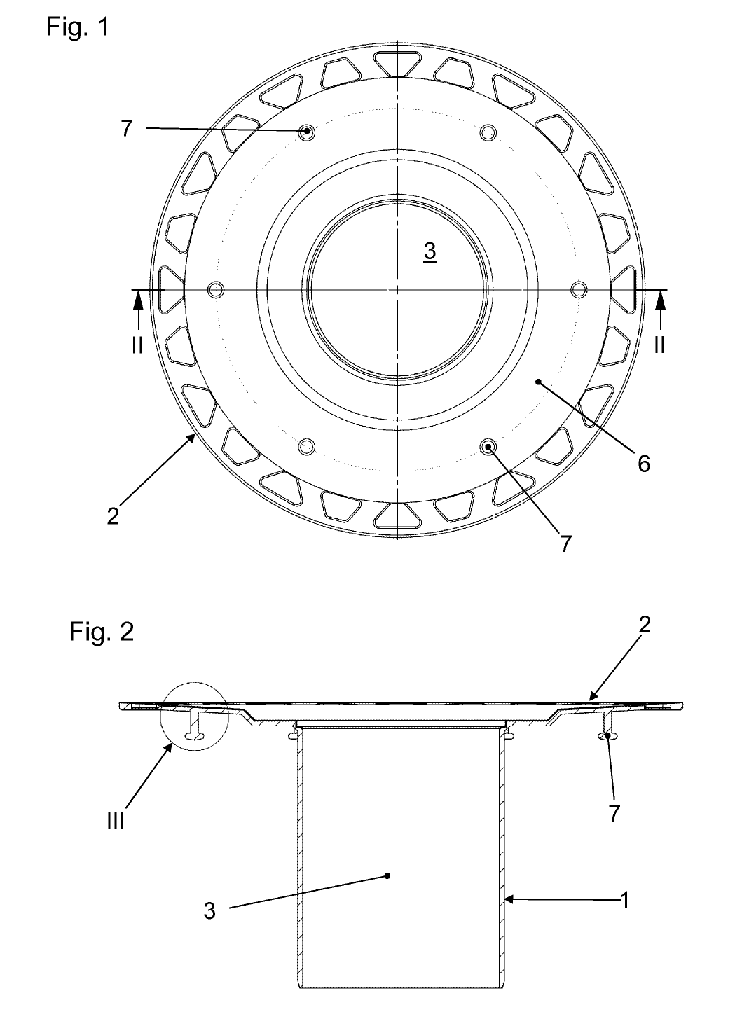

The first embodiment of a drain component illustrated in FIGS. 1 to 3 is constructed as an extension part. The drain component includes a tubular section 1, with a flange 2 projecting radially outwardly at the top in the installed position. The tubular section 1 may, for example, be inserted into a drain bowl a drain assembly. The flange 2 may serve as a base for a composite waterproof seal and tiles applied thereon.

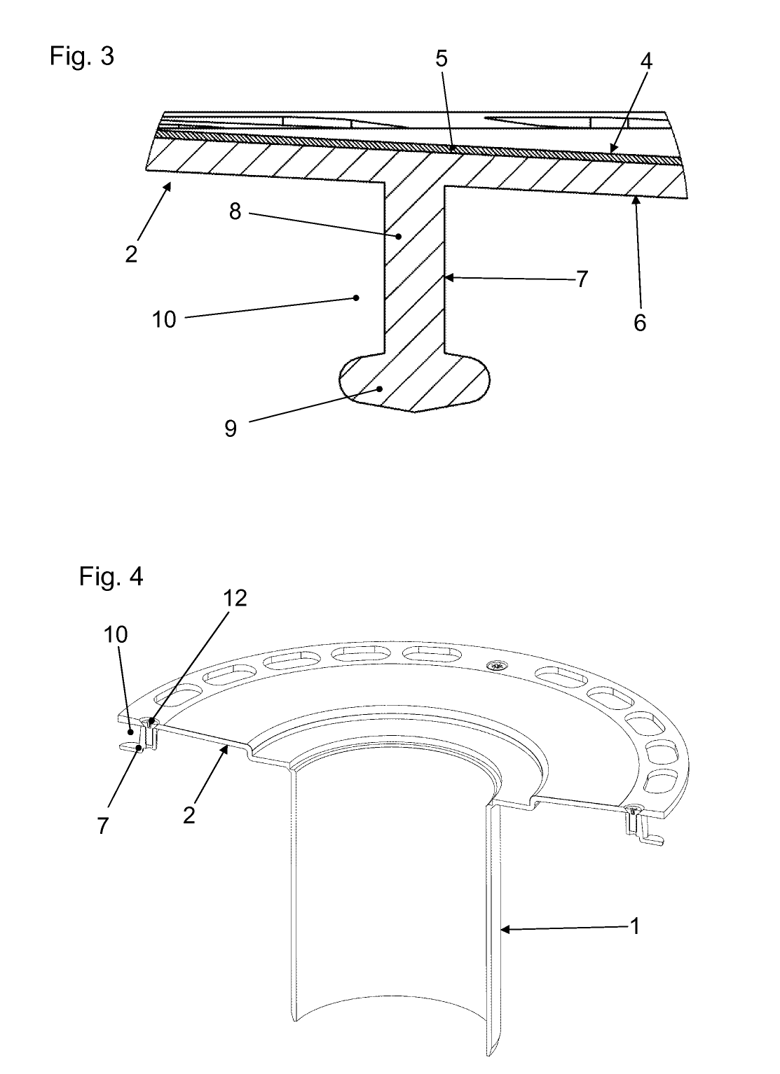

The tubular section 1 has a central opening 3 for the passage of waste water. The flange 2 has, as viewed in the installed position, on its top side 4 a fleece 5 which is molded on or injected in the top side 4 of the flange 2, as viewed in the installed position (see FIG. 3). The fleece 5 may, for example, serve as an adhesion bridge for a composite waterproof seal and as an adhesion bridge for the adhesives.

A plurality of connecting elements 7 are arranged on the bottom side 6 of the flange 2, as viewed in the installed position (see FIG. 1 through FIG. 3). In the illustrated embodiment, the connecting elements 7 include a first cylindrical section 8 extending downwardly from the bottom side 6 and an adjoining second cylindrical section 9 having a diameter which is larger than the diameter of the first section 8. This creates an intermediate space 16 or undercut disposed between the second section 9 and the bottom side 6 of the flange 2. For example, a screed may penetrate into this intermediate space 10 during its formation, creating an interlocking connection between the screed and the connecting elements 7.

Moreover, one, several or all the connecting elements 7 may have a different cross-sectional shape, such as for example a triangular, a square, a polygonal cross-sectional shape, or may have the shape of a droplet; or one, several or all the connecting elements may be formed as webs aligned parallel to the bottom side 6.

In the embodiment illustrated in FIGS. 1 to 3, the connecting elements 7 are an integral part of the drain component. For example, in one embodiment, they are co-molded as a single injection molded part.

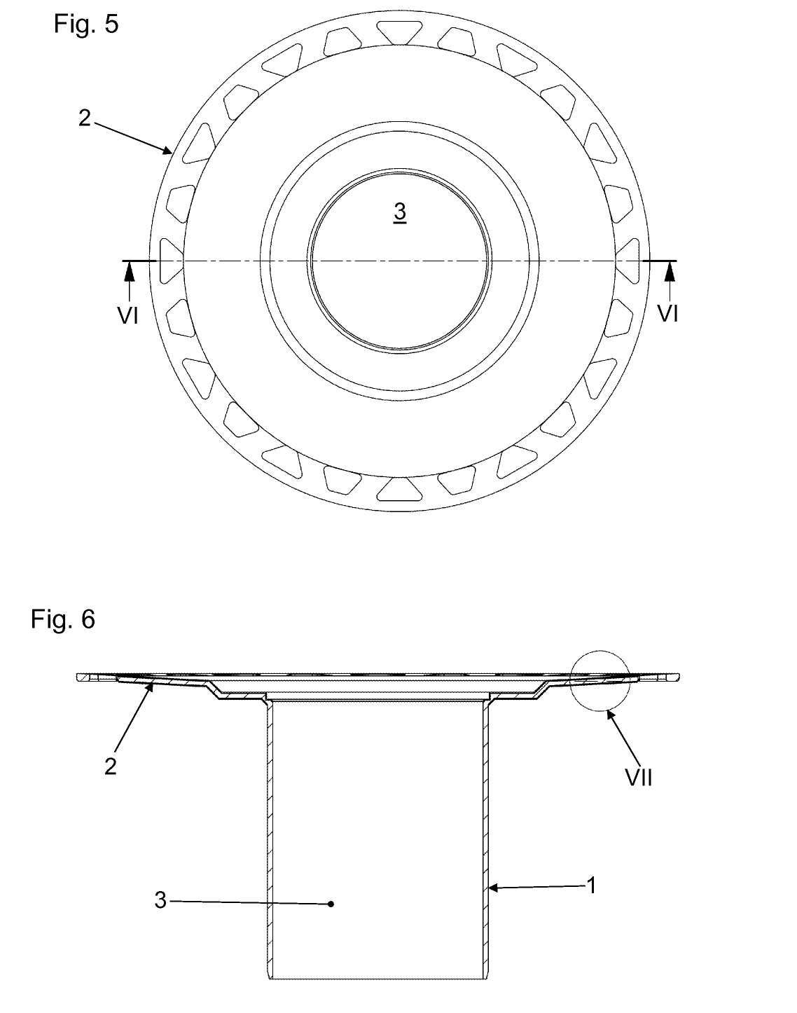

In the second embodiment shown in FIG. 4, the connecting elements 7 are detachably connected to the drain component with screws 12. Furthermore, the connecting elements 7 shown in FIG. 4 are a hook-shaped, whereas the first embodiment illustrated in FIGS. 1 to 3 has instead a mushroom shape. However, hook-shaped connecting elements 7 which are integrally connected with the drain component may be provided in the first embodiment, while releasably attachable mushroom-shaped connecting elements 7 may be provided in the second embodiment.

The connecting elements 7 may have a dimension in the direction facing away from the fleece between 0.1 mm to 150 mm. For example, the dimension may be between 3 mm and 30 mm.

Moreover, the connecting elements 7 may also be arranged on the top side 4 of the flange 2, as viewed in the installed position. Furthermore, when the drain component is bowl-shaped or shaped otherwise, connecting elements may be provided at any location.

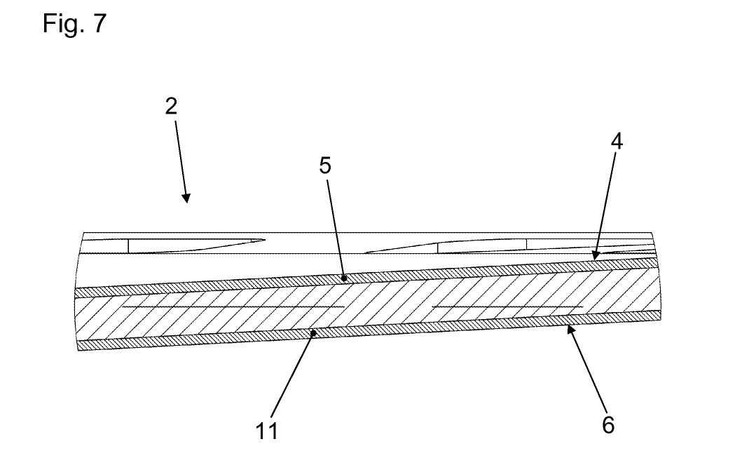

The third embodiment illustrated in FIGS. 5 to 7 differs from the first two embodiments in that no individual connecting elements 7 are provided, but that instead a fleece 11 is arranged on the bottom side 6. As viewed the installed position, the fleece 11 may be molded on or injected in the bottom side 6 of the flange 2 (see FIG. 7). The fleece 11 is designed to form a material connection with the screed or with other layers of the floor structure.

Flocking may be provided in place of the fleece as a connecting means. The flocking may here include synthetic fibers, such as for example polyamide fibers or polyester fibers, or natural fibers, such as for example flax or hemp.

Such flocking may be produced, for example, by pre-treating the surface of the drain component to be flocked and subsequently applying an adhesive. Thereafter, suitable chemically processed flocks or fibers may be applied to the adhesive layer. After the drain component or the flocking applied thereto has dried, the flocking may also serve as an effective adhesion bridge to the surrounding layers of the floor structure, such as a screed and/or to a composite waterproof seal and/or to a the adhesive and/or to a concrete section and/or a wooden section of the floor assembly.

Alternatively, the flocks or fibers may be directly injected in or molded on the plastic material of the surface of the drain member to be flocked.

The fleece 5, 11 and/or the flocking may not be arranged over the entire area, but only in sections on the surface of the drain component, in particular on the bottom side 6 and/or on the top side 4 of the flange 2.

For example, the flocking or the fleece 5, 11 on the bottom side 6 and/or on the top side 4 of the flange 2 may be interrupted by at least one unflocked surface, or a surface lacking a fleece, for example an annular surface. Furthermore, these annular surfaces may also be connected with each other by unflocked radially extending channels, or by radially extending channels lacking a fleece.

Alternatively, at least one unflocked, radially inwardly extending channel or a radially inwardly extending channel lacking a fleece may run from the innermost unflocked annular surface, or from the annular surface lacking a fleece, to the drain opening.

Likewise, at least one unflocked, radially outwardly extending channel or a radially outwardly extending channel lacking a fleece may run from the outermost unflocked annular surface, or from the annular surface lacking a fleece, to the adjacent floor structure.

As further variants, two-dimensional geometries, which are unflocked or which lack a fleece and which may be interconnected or arranged separately, may be envisioned. For example, segmented surfaces, in particular surfaces in form of circular segments may be provided with flocking or with a fleece, wherein every second segment is not provided with a fleece or with flocking.

Instead of the extension parts serving as a drain component shown in the Figures, other drain components, such as drain components in form of a drain bowl or a pipe, may be provided with the connecting means according to the invention.

Other geometries, such as an elongated channel-shaped geometry, may be provided instead of the rotationally-symmetric geometry of the tubular portion 1. Even with such an elongated channel-shaped geometry, a flange may protrude outwardly from the top side of the corresponding section, which is then also not rotationally-symmetric, but is instead elongated.

The surface provided with connecting means according to the invention may also be part of a channel-shaped floor drain.

1. A drain component having a surface which, in the installed state of the drain component, comes at least partially into contact with one or several layers of a floor structure, wherein connecting means for connecting to one or several layers of the floor structure are disposed at least partially on the surface of the drain component.

2. The drain component according to claim 1, wherein the connecting means are formed as flocking or include flocking.

3. The drain component according to claim 2, wherein the flocking comprises synthetic fibers such as one of polyamide fibers, polyester fibers and natural fibers.

4. The drain component according to claim 1, wherein the connecting means comprise a fleece.

5. The drain component according to claim 4, wherein the fleece is molded on or injected in the surface of the drain component at least in sections.

6. The drain component according to claim 2, wherein the fleece is designed so as to form a material connection with one or several layers of the floor structure.

7. The drain component according to claim 1, wherein the connecting means comprise at least one connecting element, which in the installed position protrudes at least partially, away from the surface of the drain component.

8. The drain component according to claim 7, wherein an intermediate space is present in sections between a section of the at least one connecting element and the surface of the drain component.

9. The drain component according to claim 7, wherein the at least one connecting element is formed integrally with the drain component.

10. The drain component according to claim 7, wherein the at least one connecting element (7) is constructed so as to form an interlocking connection with one or several layers of the floor structure.

11. The drain component according to claim 1, wherein the connecting means are constructed so as to form a material connection.

12. The drain component according to claim 1, wherein the drain component comprises a tubular or elongated channel-shaped section through which waste water can pass, and a flange extending outwardly from the tubular or elongated channel-shaped portion, wherein the connecting means for connection to one or several layers of the floor structure are arranged on the flange.

13. The drain component according to claim 12, wherein the connecting means are arranged on the bottom side of the flange, when viewed in the installed position, and/or on the top side (4) of the flange (2), when viewed in the installed position.

14. The drain component according to claim 1, wherein the drain component is formed as an extension part for a drain assembly.

15. The drain component according to claim 1, wherein the drain component is part of a drain assembly, wherein the tubular or elongated channel-shaped section is part of a drain bowl.

16. The drain component according to claim 2, wherein the synthetic fibers is one of polyamide fibers, polyester fibers, natural fibers.

17. The drain component according to claim 16, wherein the natural fibers are flax or hemp.

18. The drain component according to claim 2, wherein the fleece is fibers or flocks used as flocking which are molded on or injected in the surface of the drain component at least in sections.

19. The drain component according to claim 9, wherein the at least one connecting element is formed detachably via one of a screw connection, a clip connection and a catch connection.

20. The drain component according to claim 7, wherein the at least one connecting element is formed integrally with the drain component.

21. The drain component according to claim 7, wherein the connecting element with the drain component, in detachable.

22. The drain component according to claim 1, wherein the connecting means are constructed so as to form a material connection and/or an interlocking connection with a screed and one of a composite waterproof seal, a tile adhesive, a concrete section, and a wooden section of the floor structure.
